(19) United States
(12) Patent Application Publication
(10) Pub. No.: US 2023/0064245 A1
(43) Pub. Date: Mar. 2, 2023

(54) BATTERY PACK FOR ELECTRIC PASSENGER VEHICLE

(71) Applicant: Indiev, Inc, Los Angeles, CA (US)

(72) Inventor: Thomas Gage, Los Angeles, CA (US)

(21) Appl. No.: 17/458,930

(22) Filed: Aug. 27, 2021

(51) Int. Cl. B60K 1/04; B60L 50/64; H01M 50/271; H01M 50/213; H01M 50/262; H01M 10/6554; H01M 50/502; H01M 50/289

(52) U.S. Cl. CPC B60K 1/04; B60L 50/64; H01M 50/271; H01M 50/213; H01M 50/262; H01M 10/6554; H01M 50/502; H01M 50/289; H01M 2220/20

(57) ABSTRACT

Battery packs for electric passenger vehicles are provided. A battery pack can include a housing with a frame and a plurality of structural cross-members defining module spaces for battery modules to be disposed within the housing. The battery pack can also include a lid cover to go over the housing and enclose the battery modules within the housing and lid cover. The structural cross-members can define pairs of horizontally-adjacent module spaces, where pairs of battery modules can be disposed.

### BACKGROUND

Electric passenger vehicles are becoming more prevalent, leading to a need for better batteries for such vehicles. Multiple batteries can be used together in battery packs. Existing battery packs have many drawbacks.

### BRIEF SUMMARY

Embodiments of the subject invention provide novel and advantageous battery packs for electric passenger vehicles, as well as methods of using the same and methods of fabricating the same. A battery pack can include a housing with a frame and a plurality of structural cross-members defining module spaces for battery modules to be disposed within the housing. The battery pack can also include a lid cover to go over the housing and enclose the battery modules within the housing and lid cover. The structural cross-members can define pairs of horizontally-adjacent module spaces, where pairs of battery modules can be disposed. The battery pack provides versatility and allows for compact current flow. The battery pack can be adapted to a variety of configurations. Battery modules can be removed, shifted around, or even split to control the ballast weight within the electric passenger vehicle architecture.

In an embodiment, a battery pack for electric passenger vehicles can comprise: a housing comprising a frame and a plurality of structural cross-members defining a plurality of module space pairs within the housing; and a plurality of battery modules respectively disposed in pairs in module space pairs of the plurality of module space pairs. Within each module space pair, two battery modules can be disposed and can be electrically connected to each other via an interconnection. Each battery module of the plurality of battery modules can be electrically connected to a conductive line running through the housing, the conductive line being electrically connected to at least one external contact configured to connect to the electric passenger vehicle. The housing can further comprise a buffer space between, in a length-wise direction of the battery pack, the plurality of module space pairs and an end portion of the housing. The frame of the housing can comprise a plurality of housing fasteners. The frame of the housing can be an extruded frame, and/or the housing can be an extruded housing. The plurality of module space pairs can comprise, for example, five module space pairs comprising ten module spaces. The plurality of battery modules can comprise, for example, ten battery modules. The plurality of structural cross-members can comprise, for example, at least five structural cross-members. The plurality of structural cross-members can comprise at least five structural cross-members defining five module space pairs. The battery pack can further comprise a lid cover disposed on the housing and covering an opening of the housing, such that the plurality of battery modules are enclosed within the housing and the lid cover. The lid cover can be removably attached to the housing (e.g., via at least one cover fastener that goes through the lid cover and fastens it to the housing). The lid cover can comprise a plurality of embossed portions or cover view windows. If cover view windows are present, each cover view window of the plurality of cover view windows can comprise a transparent material. The embossed portions (or cover view windows) can be respectively provided over battery modules of the plurality of battery modules and/or over structural cross-members of the plurality of structural cross-members. A width of the battery pack, measured in a first direction in which the structural cross-members run, can be in a range of, for example, from 4 feet to 6 feet. A length of the battery pack, measured in a second direction perpendicular to the first direction and parallel to a lower surface of the housing, can be in a range of, for example, from 6 feet to 15 feet. A thickness of the battery pack, measured in a third direction perpendicular to the first direction, the second direction, and the lower surface of the housing, can be in a range of, for example, from 2 inches to 24 inches. The thickness of the housing, measured in the third direction, can be large enough for the plurality of battery modules to be disposed in the housing and be laterally completely contained within the housing.

### BRIEF DESCRIPTION OF DRAWINGS

FIG. 1 shows a plan view of a battery pack, according to an embodiment of the subject invention.

FIG. 2 shows a plan view of a battery pack, according to an embodiment of the subject invention.

FIG. 3 shows an isometric view of a battery pack with a lid cover, according to an embodiment of the subject invention.

FIG. 4 shows a top view of a battery pack with a lid cover, according to an embodiment of the subject invention.

FIG. 5 shows a top view of the battery pack of FIG. 4, with the lid cover removed.

FIG. 6A shows an isometric view of a top of a battery module that can be used with a battery pack, according to an embodiment of the subject invention.

FIG. 6B shows an isometric view of a bottom of the battery module of FIG. 6A.

FIG. 7 shows an exploded view of a battery module that can be used with a battery pack, according to an embodiment of the subject invention.

FIG. 8A shows an isometric view of a cooling plate assembly (with a top plate) of a battery module that can be used with a battery pack, according to an embodiment of the subject invention.

FIG. 8B shows an isometric view of the cooling plate assembly of FIG. 8A, without the top plate.

FIG. 9 shows an isometric view of a pair of battery modules that can be disposed in a battery pack, according to an embodiment of the subject invention.

### DETAILED DESCRIPTION

Embodiments of the subject invention provide novel and advantageous battery packs for electric passenger vehicles, as well as methods of using the same and methods of fabricating the same. A battery pack can include a housing with a frame and a plurality of structural cross-members defining module spaces for battery modules (i.e., individual batteries that combine with the others in the battery pack to make up the full battery of the electric passenger vehicle) to be disposed within the housing. The battery pack can also include a lid cover to go over the housing and enclose the battery modules within the housing and lid cover. The structural cross-members can define pairs of horizontally-adjacent module spaces, where pairs of battery modules can be disposed. The battery pack provides versatility and allows for compact current flow. The battery pack can be adapted to a variety of configurations (e.g., by only changing the current collector design/configuration of one or more of the battery modules). Battery modules can be removed, shifted around (e.g., forward or rearward) (i.e., by having the module spaces shifted around), or even split to control the ballast weight within the electric passenger vehicle architecture.

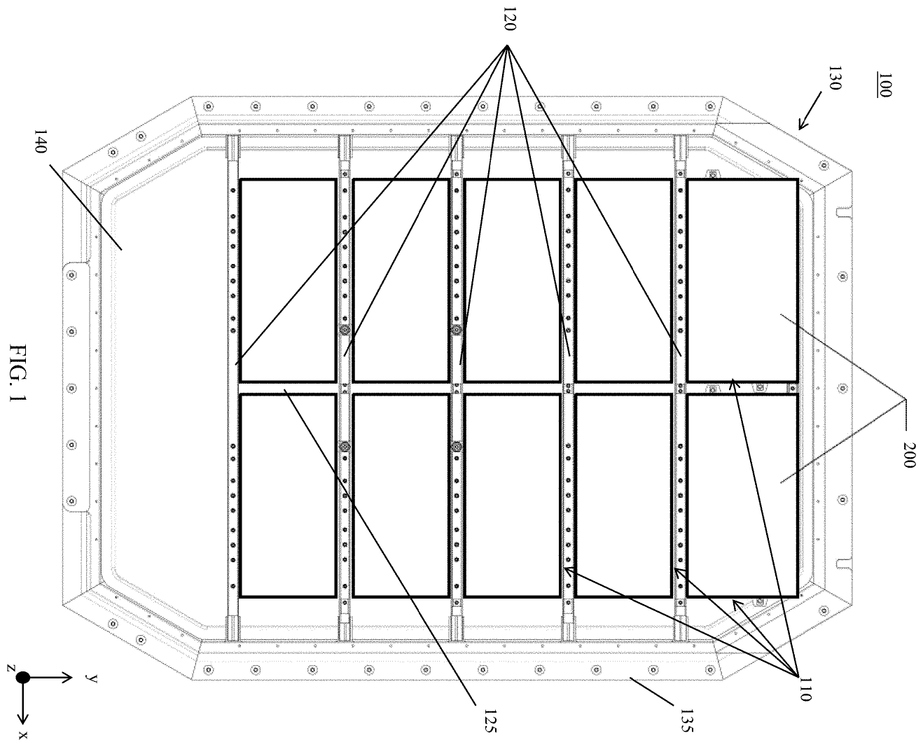

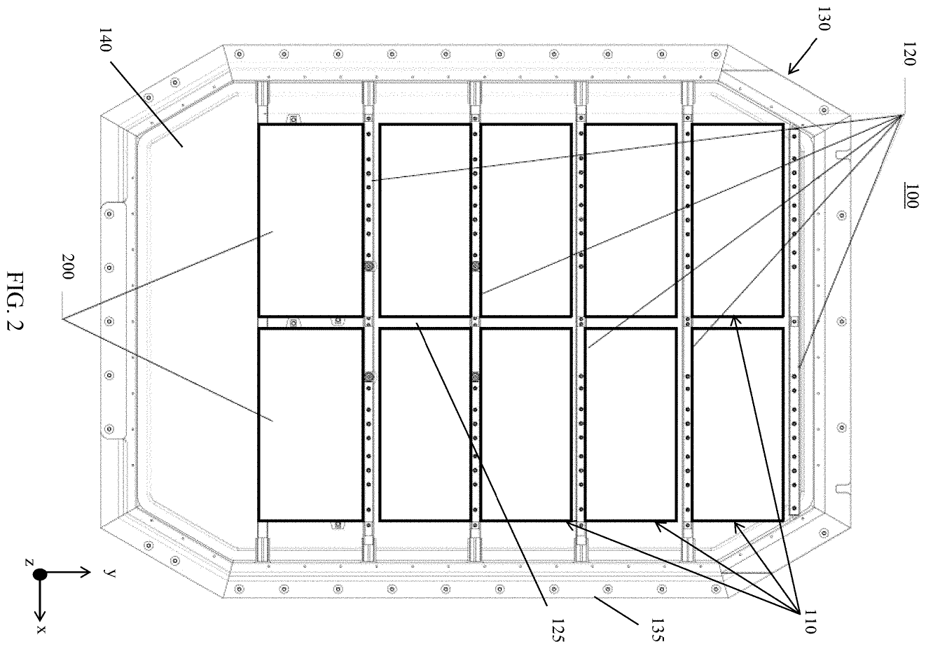

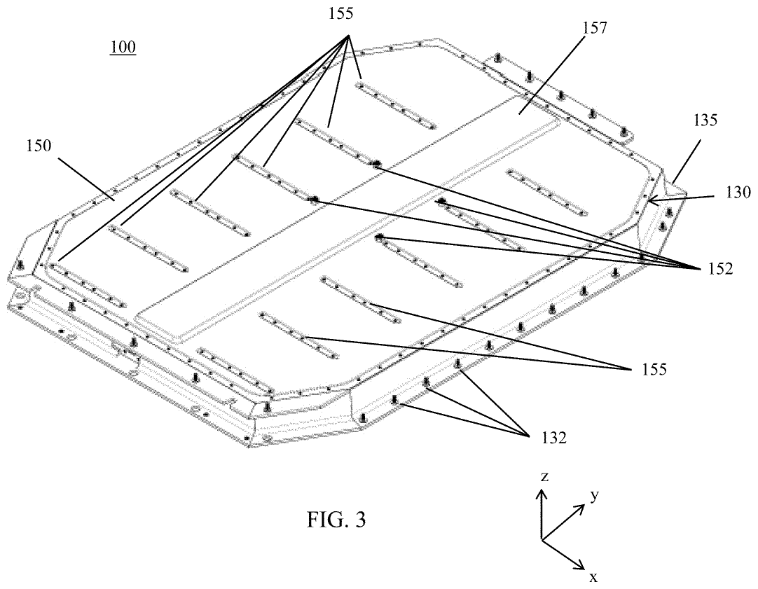

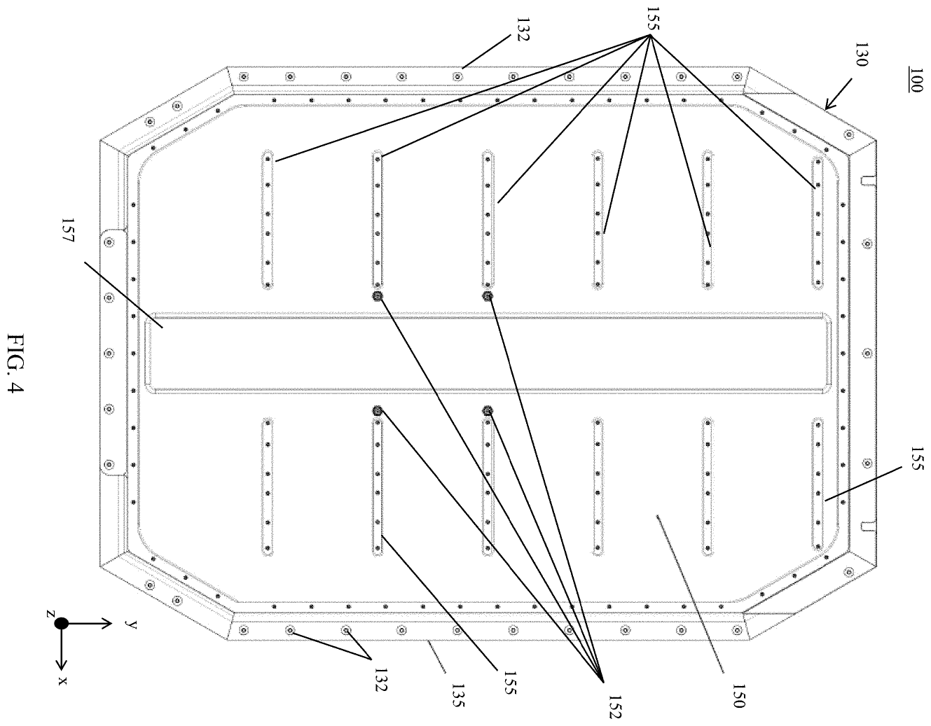

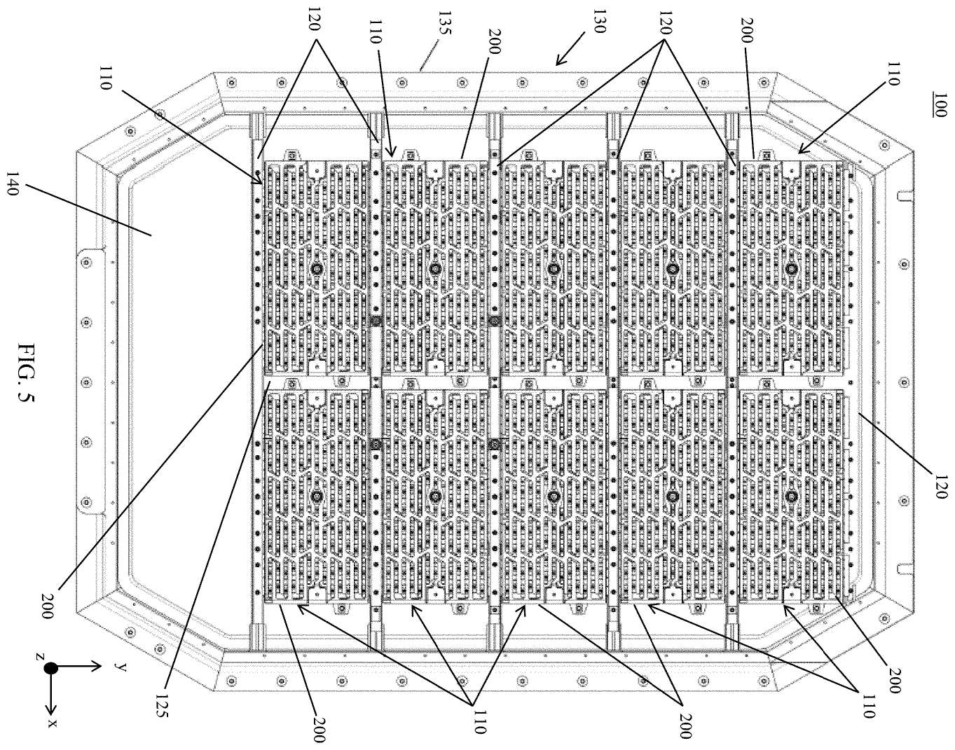

FIG. 1 shows a plan view of a battery pack, according to an embodiment of the subject invention, and FIG. 2 shows a plan view of a battery pack, according to a similar embodiment having the locations of the battery modules and structural cross-members moved slightly relative to one another, as compared to the embodiment shown in FIG. 1. FIG. 3 shows an isometric view of a battery pack with a lid cover, and FIG. 4 shows a top view of a battery pack with a lid cover, according to an embodiment of the subject invention. FIG. 5 shows a top view of the battery pack of FIG. 4, with the lid cover removed. The battery modules in FIG. 5 are depicted in a more detailed manner than they are in FIGS. 1 and 2 (in which they are represented by blocks), but this does not change the function within the battery pack.

Referring to FIGS. 1-5, a battery pack 100 can comprise a housing 130 comprising a frame 135 and a plurality of structural cross-members 120 defining module spaces 110 for battery modules 200 to be disposed within the housing 130. The battery pack can further comprise a lid cover 150 to go over the housing 130 and enclose the battery modules 200 within the housing 130 and lid cover 150. A pair of battery modules 200 can be disposed between structural cross-members 120 and/or between a structural cross-member 120 and an end portion (upper or lower, in the y-direction as depicted in the figures) of the housing 130. In this way, the structural cross-members 120 can define pairs of module spaces 110 for respective pairs of battery modules 200 to be disposed. The housing 130 can have an opening, for example in its thickness direction (in the z-direction as depicted in the figures), to allow the battery modules to be placed in the housing, examined, changed out, or removed. The lid cover 150 can be sized to meet and/or cover the housing frame 135, so as to completely cover the opening of the housing 130 (other than any openings that may be present in the lid cover 150 itself).

The housing 130 can optionally include a length-wise structural member, perpendicular to and crossing the structural cross-members 120 (the location for such a length-wise structural member is denoted with reference numeral 125 in FIGS. 1, 2, and 5); though, in many embodiments such a length-wise structural member is excluded and there is pairs of battery modules 200 between structural cross-members 120 (or between a structural cross-member 120 and an end portion of the housing 130) are in direct contact with each other.

The housing 130 can optionally include a buffer space 140 at one or both ends (upper or lower, in the y-direction as depicted in the figures) thereof. The buffer space 140 can be present to maintain the shape and/or size of the battery pack 200 (e.g., in order to fit on the electric passenger vehicle) without the requirement of increasing the size or quantity of battery modules 200 present in the battery pack 100. Alternatively, additional battery modules 200 and/or structural cross-members 120 can be present in the buffer space 140 shown in FIGS. 1, 2, and 5.

The frame 135 of the housing 130 can be, for example, an extruded housing frame (i.e., fabricated by an extrusion process). The entire housing 130 can be, for example, an extruded housing (i.e., fabricated by an extrusion process). The housing can optionally include one or more housing fasteners 132 around the frame 135. Such fasteners 132 can be any suitable fastener (e.g., screws, pins, bolts, rivets, anchors, nails).

Though the figures depict ten battery modules 200 in ten module spaces 110 (five pairs of module spaces 110), this is for exemplary purposes only and should not be construed as limiting. Battery modules 200 can be removed, added, shifted around (e.g., forward or rearward (i.e., upward or downward in the y-direction as depicted in the figures); i.e., by having the module spaces 110 shifted around), or even split to control the ballast weight within the electric passenger vehicle architecture. Also, the positioning and/or quantity of the structural cross-members 120 can be altered depending on the desired configuration. For example, FIG. 1 depicts an embodiment with five structural cross-members 120 defining five pairs of module spaces 110 (together with the upper end of the housing 130) for ten battery modules 200, including having a buffer space 140 directly adjacent to a structural cross-member 120 (with no battery module 200 therebetween). FIG. 2 depicts an embodiment with five structural cross-members 120 defining five pairs of module spaces 110 (together with the buffer space 140 at the lower end of the housing 130) for ten battery modules 200, including having a buffer space 140 directly adjacent to a pair of battery modules 200 (with no structural cross-members 120 therebetween), and with a structural cross-member 200 directly adjacent to the upper end of the housing 130 (with no battery module 200 therebetween). FIG. 5 depicts an embodiment with six structural cross-members 120 defining five pairs of module spaces 110 for ten battery modules 200, including having a buffer space 140 directly adjacent to a structural cross-member 120 (with no battery module 200 therebetween), and with a structural cross-member 200 directly adjacent to the upper end of the housing 130 (with no battery module 200 therebetween).

The lid cover 150 can be sized to fit over the opening of the housing 130, such that when the lid cover 150 is in place, the battery modules 200 are completely enclosed within the housing 130 and the lid cover 150. The lid cover 150 can be removably attached to the housing 130 (e.g., via an adhesive and/or via cover fasteners 152). One or more cover fasteners 152 can be used to go through the lid cover 150 and fasten it to the housing 130, and may be any suitable fastener (e.g., screws, pins, bolts, rivets, anchors, nails). The cover fastener(s) 152 can be located anywhere on the lid cover, for example near the center in both the width (x-direction as depicted in the figures) and length (y-direction as depicted in the figure) directions, as depicted in FIGS. 3 and 4. Though, the locations and quantity of cover fasteners 152 depicted in FIGS. 3 and 4 is for exemplary purposes only and should not be construed as limiting.

The lid cover 150 can optionally include one or more cover view windows 155, which can comprise a transparent material (e.g., glass or other transparent material (e.g., plastic)) or can simply be empty openings in the lid cover 150. The cover view window(s) 155, if present, can be provided over the battery modules 200 (e.g., to provide for easy monitoring of the battery modules 200) or over the structural cross-members 120. The lid cover can optionally include a raised central bar 157 thereon running longitudinally (the y-direction as depicted in the figures) down the width-wise (the x-direction as depicted in the figures) center of the upper surface of the cover lid 150. The raised central bar 157, if present, can structurally reinforce the lid cover 150 and/or can be for aesthetic purposes.

The battery pack 100 can have a width (in the x-direction as depicted in the figures) of any of the following values, at least any of the following values, at most any of the following values, or any range or subrange having any of the following values as endpoints (all values are in feet (ft)): 0.5, 1, 1.5, 2, 2.5, 3, 3.5, 4, 4.5, 5, 5.5, 6, 6.5, 7, 7.5, 8, 8.5, 9, or 10. For example, the width of the battery pack can be in a range of from 4 ft to 5 ft.

The battery pack 100 can have a length (in the y-direction as depicted in the figures) of any of the following values, at least any of the following values, at most any of the following values, or any range or subrange having any of the following values as endpoints (all values are in ft): 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 19, or 20. For example, the length of the battery pack can be in a range of from 6 ft to 15 ft.

The battery pack 100 can have a thickness (in the z-direction as depicted in the figures) of any of the following values, at least any of the following values, at most any of the following values, or any range or subrange having any of the following values as endpoints (all values are in inches (in)): 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 19, 20, 21, 22, 23, or 24. For example, the thickness of the battery pack can be in a range of from 2 in to 12 in (e.g., from 2 in to 8 in).

The housing 130 of the battery pack 100 can have a depth or thickness (in the z-direction as depicted in the figures) configured to be large enough for the battery modules 200 to be disposed in the housing and have the upper surfaces thereof not extend above the upper surface of the housing 130 (i.e., the battery modules 200 can be laterally completely contained within the housing 130).

The term “direct contact” as used herein when referring to two elements being in “direct contact” with each other refers to the case where the two elements have only an adhesive between them (with no other intervening elements) or are in direct physical contact with each other (with no intervening elements at all). The term “direct physical contact” as used herein when referring to two elements being in “direct physical contact” with each other refers to the case where the two elements are directly, physically contacted with each other such that there are no intervening elements at all.

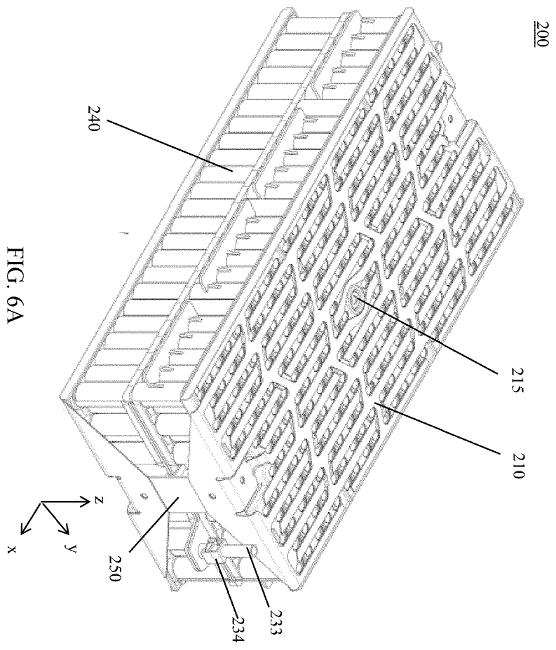

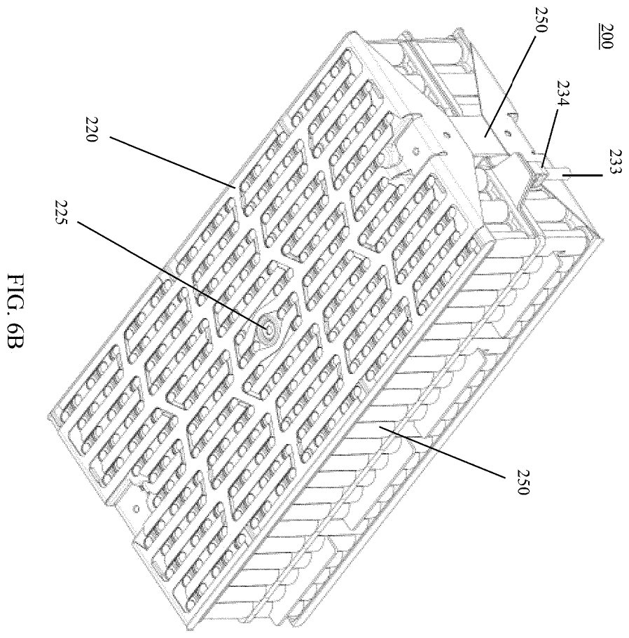

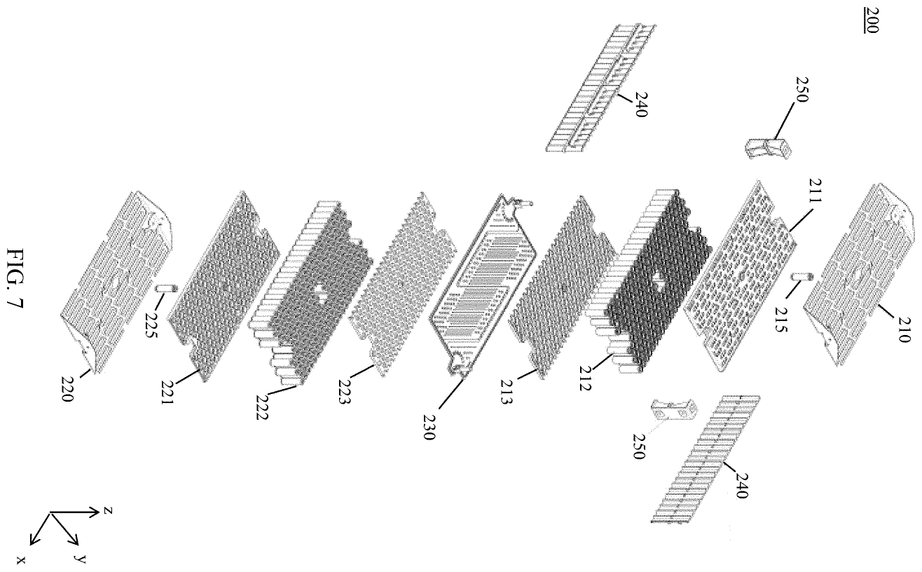

FIGS. 6A and 6B show isometric views of a top and a bottom, respectively, of a battery module 200 that can be used with battery packs 100 of embodiments of the subject invention, and FIG. 7 shows an exploded view of the battery module 200. Referring to FIGS. 6A, 6B, and 7, a battery module 200 can include a cooling plate 230, an upper level negative cell tray 213 disposed on (and optionally in direct contact with or in direct physical contact with) the cooling plate 230, an upper level battery cell array 212 disposed on (and optionally in direct contact or in direct physical contact with) the upper level negative cell tray 213, an upper level positive cell tray 211 disposed on (and optionally in direct contact or in direct physical contact with) the upper level battery cell array 212, and a top current collector assembly 210 disposed on (and optionally in direct contact or in direct physical contact with) the upper level positive cell tray 211. The battery module 200 can further include a bottom current collector assembly 220, a lower level positive cell tray 221 disposed on (and optionally in direct contact or in direct physical contact with) the bottom current collector assembly 220, a lower level battery cell array 222 disposed on (and optionally in direct contact or in direct physical contact with) the lower level positive cell tray 221, and a lower level negative cell tray 223 disposed on (and optionally in direct contact or in direct physical contact with) the lower level battery cell array 222. The cooling plate 230 can be disposed on (and optionally in direct contact or in direct physical contact with) the lower level negative cell tray 223. That is, the battery module 200 can have a stacked structure of the bottom current collector assembly 220, the lower level positive cell tray 221, the lower level battery cell array 222, the lower level negative cell tray 223, the cooling plate 230, the upper level negative cell tray 213, the upper level battery cell array 212, the upper level positive cell tray 211, and the top current collector assembly 210.

The battery module 200 can further include one or more main terminal holders 250 on respective ends (in the x-direction as depicted in the figures) of the battery module 200, as well as side caps 240 covering the respective lateral sides (covering from the y-direction as depicted in the figures) of the upper and lower level positive and negative trays 211,213,221,223 and battery cell arrays 212,222. The upper level portion of the battery module 200 can include an upper level center fastener 215 that can go through a hole of (and/or connect) the top current collector assembly 210, the upper level positive cell tray 211, the upper level battery cell array 212, and/or the upper level negative cell tray 213 (e.g., connect to each other). The lower level portion of the battery module 200 can include a lower level center fastener 225 that can go through a hole of (and/or connect) the bottom current collector assembly 220, the lower level positive cell tray 221, the lower level battery cell array 222, and/or the lower level negative cell tray 223 (e.g., connect to each other). Each of the upper level center fastener 215 (if present) and the lower level center fastener 225 (if present) may be any suitable fastener (e.g., screw, pin, bolt, rivet, anchor, nail). For example, the upper level center fastener 215 can be a bolt, and the lower level center fastener 225 can be a bolt. In an embodiment, a single center fastener (e.g., center tube and/or center bolt assembly) can go through respective holes of the top current collector assembly 210, the upper level positive cell tray 211, the upper level battery cell array 212, the upper level negative cell tray 213, the cooling plate 230, the lower level negative cell tray 223, the lower level battery cell array 222, the lower level positive cell tray 221, and the bottom current collector assembly 220 to clamp the entire battery module 200 together.

In an alternative embodiment, the upper level positive cell tray 211 and the upper level negative cell tray 213 can be switched, such that the upper level positive cell tray 211 is disposed between (and optionally in direct contact or in direct physical contact with) the upper level battery cell array 212 and the top current collector assembly 210, and the upper level negative cell tray 213 is disposed between (and optionally in direct contact or in direct physical contact with) the cooling plate 230 and the upper level battery cell array 212.

In an alternative embodiment, the lower level positive cell tray 221 and the lower level negative cell tray 223 can be switched, such that the lower level positive cell tray 221 is disposed between (and optionally in direct contact or in direct physical contact with) the lower level battery cell array 222 and the cooling plate 230, and the lower level negative cell tray 223 is disposed between (and optionally in direct contact or in direct physical contact with) the bottom current collector 220 and the lower level battery cell array 222.

The side caps 240 can be, for example, scalloped side caps 240. The scalloped shape can allow for tight coupling with the battery arrays 212,222 when the side caps 240 are put in position.

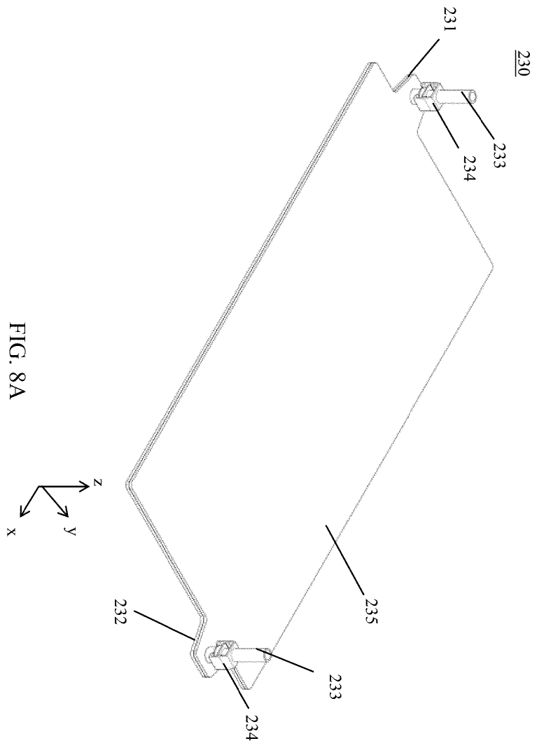

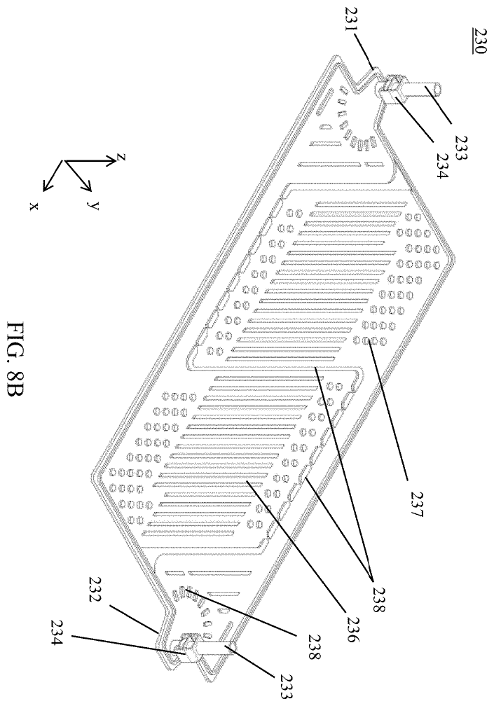

FIGS. 8A and 8B show isometric views of the cooling plate 230 with and without a top plate, respectively. Referring to FIGS. 8A and 8B, the cooling plate 230 of the battery module 200 can optionally include a top plate 235. The cooling plate 230 can include grooves 236, dimples 237, and/or other indentations or protrusions 238 on an upper and/or lower surface thereof. The cooling plate 230 can include a first end protrusion 231 and/or a second end protrusion 232 protruding from the respective ends thereof (in the x-direction as depicted in the figures). The end protrusions 231,232 can include a post 233 and/or a connector 234 disposed thereon and extending in the thickness direction of the battery module (the z-direction as depicted in the figures), for example extending upwards towards the direction of the top current collector assembly 210 (or downwards towards the direction of the bottom current collector assembly 220). The posts 233 can be used as, for example, a means of providing coolant and/or coolant flow to the battery module 200.

Any (but not all within the same embodiment) of the bottom current collector assembly 220, the lower level positive cell tray 221, the lower level battery cell array 222, the lower level negative cell tray 223, the cooling plate 230, the upper level negative cell tray 213, the upper level battery cell array 212, the upper level positive cell tray 211, the top current collector assembly 210, the upper level center fastener 215, the lower level center fastener 225, the side caps 240, and the main terminal holders 250 can be made of a conductive material. Of course, the upper level battery cell array 212 and/or the lower level battery cell array 222 can include an electrolyte and/or other battery material. In some embodiments, the upper level center fastener 215, the lower level center fastener 225, the side caps 240, the main terminal holders 250, and/or the cooling plate 230 may optionally comprise non-conductive materials.

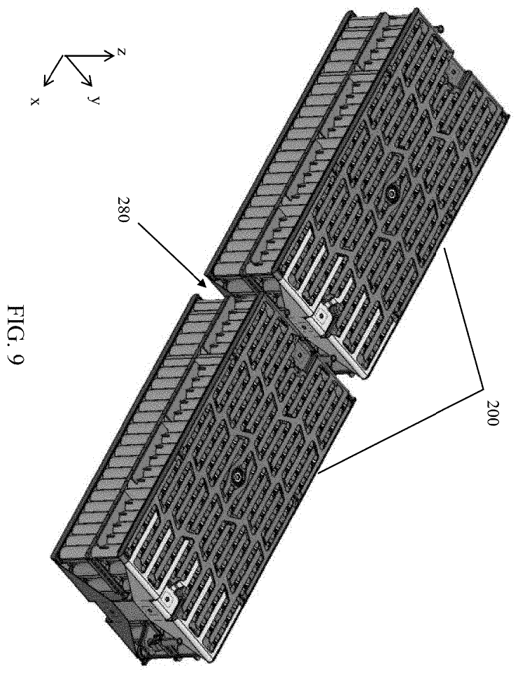

FIG. 9 shows an isometric view of a pair of battery modules 200 that can be disposed in the battery pack 100. Referring to FIG. 9, the battery modules 200 can be disposed side-by-side in the width direction of the battery pack (the x-direction as depicted in the figures). The battery modules can be electrically connected to each other (e.g., via a middle interconnection 280 between (in the x-direction as depicted in the figures) the two battery modules 200. The battery modules 200 can also include at least one vertical interconnection at an end of at least one battery module 200 of the interconnected pair of battery modules 200. This can be used to connect to at least one conductive line (not pictured) of the battery pack 100 that can electrically connect each pair of battery modules 200 (or even directly each individual battery module 200) to all other battery modules. The conductive line(s) can connect to one or more contacts that can be used to connect the battery pack 100 to the electric passenger vehicle to provide battery power thereto.

The transitional term “comprising,” “comprises,” or “comprise” is inclusive or open-ended and does not exclude additional, unrecited elements or method steps. By contrast, the transitional phrase “consisting of” excludes any element, step, or ingredient not specified in the claim. The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

When ranges are used herein, combinations and subcombinations of ranges (e.g., subranges within the disclosed range), specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

The subject invention includes, but is not limited to, the following exemplified embodiments.

Embodiment 1. A battery pack for electric passenger vehicles, the battery pack comprising:

a housing comprising a frame and a plurality of structural cross-members defining a plurality of module spaces within the housing; and

a plurality of battery modules respectively disposed in at least a portion of (or in all of) the module spaces of the plurality of module spaces.

Embodiment 2. The battery pack according to embodiment 1, wherein the plurality of structural cross-members defines a plurality of module space pairs within the housing.

Embodiment 3. The battery pack according to embodiment 2, wherein the plurality of battery modules are respectively disposed in pairs in the plurality of module space pairs (i.e., the plurality of module spaces is provided in the form of a plurality of module space pairs).

Embodiment 4. The battery pack according to embodiment 3, wherein within each module space pair, two battery modules are disposed and are electrically connected to each other via an interconnection.

Embodiment 5. The battery pack according to any of embodiments 1-4, wherein each battery module of the plurality of battery modules is electrically connected to a conductive line running through the housing, the conductive line being electrically connected to at least one external contact configured to connect to (and provide battery power to) the electric passenger vehicle.

Embodiment 6. The battery pack according to any of embodiments 1-5, wherein the housing further comprises a buffer space between, in a length-wise direction of the battery pack, the plurality of module spaces and an end portion of the housing.

Embodiment 7. The battery pack according to any of embodiments 1-6, wherein the frame of the housing comprises a plurality of housing fasteners.

Embodiment 8. The battery pack according to any of embodiments 1-7, wherein the frame of the housing is an extruded frame.

Embodiment 9. The battery pack according to any of embodiments 1-8, wherein the housing is an extruded housing.

Embodiment 10. The battery pack according to any of embodiments 1-9, wherein the plurality of module spaces comprises ten module spaces.

Embodiment 11. The battery pack according to any of embodiments 1-10, wherein the plurality of battery modules comprises ten battery modules.

Embodiment 12. The battery pack according to any of embodiments 1-11, wherein the plurality of structural cross-members comprises five structural cross-members.

Embodiment 13. The battery pack according to any of embodiments 1-11, wherein the plurality of structural cross-members comprises six structural cross-members.

Embodiment 14. The battery pack according to any of embodiments 1-13, wherein the plurality of structural cross-members comprises at least five structural cross-members defining five module space pairs (i.e., the plurality of module spaces (ten modules spaces) is provided in the form of five module space pairs).

Embodiment 15. The battery pack according to any of embodiments 1-14, wherein the battery modules of the plurality of battery modules are disposed in the housing in battery module pairs, within module space pairs of the plurality of module spaces, and wherein within each battery module pair the two battery modules are electrically connected to each other via an interconnection.

Embodiment 16. The battery pack according to any of embodiments 1-15, wherein the housing further comprises a length-wise structural member, perpendicular to and crossing the plurality of structural cross-members.

Embodiment 17. The battery pack according to any of embodiments 1-16, further comprising a lid cover disposed on the housing and covering an opening of the housing, such that the plurality of battery modules are enclosed within the housing and the lid cover.

Embodiment 18. The battery pack according to embodiment 17, wherein the lid cover is removably attached to the housing.

Embodiment 19. The battery pack according to any of embodiments 17-18, wherein the lid cover is removably attached to the housing via at least one cover fastener that goes through the lid cover and fastens it to the housing.

Embodiment 20. The battery pack according to any of embodiments 17-19, wherein the lid cover comprises at least one cover view window (e.g., a gap/hole or a window that is sealed off with transparent material).

Embodiment 21. The battery pack according to embodiment 20, wherein the at least one cover view window comprises a transparent material (e.g., glass, plastic, or other transparent material).

Embodiment 22. The battery pack according to any of embodiments 20-21, wherein the at least one cover view window is provided over at least one battery module of the plurality of battery modules.

Embodiment 23. The battery pack according to any of embodiments 20-22, wherein the at least one cover view window is provided over at least one structural cross-member of the plurality of structural cross-members.

Embodiment 24. The battery pack according to any of embodiments 17-23, wherein the lid cover comprises a raised central bar running longitudinally down an upper surface of the lid cover.

Embodiment 25. The battery pack according to any of embodiments 1-24, wherein a width of the battery pack (measured in a direction in which the structural cross-members run) is in a range of from 4 feet to 6 feet.

Embodiment 26. The battery pack according to any of embodiments 1-25, wherein a length of the battery pack (measured in a direction perpendicular to that in which the structural cross-members run and parallel to a lower surface of the housing and an upper surface of the lid cover) is in a range of from 6 feet to 15 feet.

Embodiment 27. The battery pack according to any of embodiments 1-26, wherein a thickness of the battery pack (measured in a direction perpendicular to a lower surface of the housing and an upper surface of the lid cover) is in a range of from 2 inches to 24 inches (e.g., from 2 inches to 12 inches or from 2 inches to 8 inches).

Embodiment 28. The battery pack according to any of embodiments 1-27, wherein a thickness of the housing (measured in a direction perpendicular to a lower surface of the housing and an upper surface of the lid cover) is large enough for the plurality of battery modules to be disposed in the housing and be laterally completely contained within the housing (i.e., only exposed through the opening in the upper surface of the housing on which the lid cover is disposed).

Embodiment 29. The battery pack according to any of embodiments 1-28, wherein each battery module of the plurality of battery modules comprises:

a bottom current collector assembly;

a lower level positive cell tray disposed on the bottom current collector assembly;

a lower level battery cell array disposed on the bottom current collector assembly (e.g., directly on the lower level positive cell tray);

a lower level negative cell tray disposed on the bottom current collector assembly (e.g., directly on the lower level battery cell array);

a cooling plate disposed on the bottom current collector assembly (e.g., directly on the lower level negative cell tray);

an upper level negative cell tray disposed on the cooling plate;

an upper level battery cell array disposed on the cooling plate (e.g., on the upper level negative cell tray);

an upper level positive cell tray disposed on the cooling plate (e.g., on the upper level battery cell array); and

a top current collector assembly disposed on the cooling plate (e.g., on the upper level positive cell tray).

Embodiment 30. The battery pack according to any of embodiments 1-29, wherein each battery module of the plurality of battery modules (further) comprises side caps covering respective lateral sides of the lower level positive cell tray, the lower level battery cell array, the lower level negative cell tray, the upper level negative cell tray, the upper level battery cell array, and the upper level positive cell tray.

Embodiment 31. The battery pack according to embodiment 30, wherein, within each battery module of the plurality of battery modules, the side caps are scalloped side caps.

Embodiment 32. The battery pack according to any of embodiments 1-31, wherein each battery module of the plurality of battery modules (further) comprises main terminal holders on respective ends of the battery module.

Embodiment 33. The battery pack according to any of embodiments 29-32, wherein each battery module of the plurality of battery modules further comprises an upper level center fastener that goes through respective holes of the top current collector assembly, the upper level positive cell tray, the upper level battery cell array, and the upper level negative cell tray.

Embodiment 34. The battery pack according to embodiment 33, wherein, within each battery module of the plurality of battery modules, the upper level center fastener is an upper level center bolt.

Embodiment 35. The battery pack according to any of embodiments 29-34, wherein each battery module of the plurality of battery modules further comprises a lower level center fastener that goes through respective holes of the bottom current collector assembly, the lower level positive cell tray, the lower level battery cell array, and the lower level negative cell tray.

Embodiment 36. The battery pack according to embodiment 35, wherein, within each battery module of the plurality of battery modules, the lower level center fastener is a lower level center bolt.

Embodiment 37. The battery pack according to any of embodiments 29-36, wherein each battery module of the plurality of battery modules comprises a stacked structure of (in order) the bottom current collector assembly, the lower level positive cell tray, the lower level battery cell array, the lower level negative cell tray, the cooling plate, the upper level negative cell tray, the upper level battery cell array, the upper level positive cell tray, and the top current collector assembly.

Embodiment 38. The battery pack according to any of embodiments 29-36, wherein each battery module of the plurality of battery modules comprises a stacked structure of (in order) the bottom current collector assembly, the lower level negative cell tray, the lower level battery cell array, the lower level positive cell tray, the cooling plate, the upper level positive cell tray, the upper level battery cell array, the upper level negative cell tray, and the top current collector assembly.

Embodiment 39. The battery pack according to any of embodiments 29-37, wherein, within each battery module of the plurality of battery modules:

the lower level positive cell tray is disposed directly on and in direct contact with (e.g., with only an adhesive therebetween or in direct physical contact with) the bottom current collector assembly;

the lower level battery cell array is disposed directly on and in direct contact with (e.g., with only an adhesive therebetween or in direct physical contact with) the lower level positive cell tray;

the lower level negative cell tray is disposed directly on and in direct contact with (e.g., with only an adhesive therebetween or in direct physical contact with) the lower level battery cell array;

the cooling plate is disposed directly on and in direct contact with (e.g., with only an adhesive therebetween or in direct physical contact with) the lower level negative cell tray;

the upper level negative cell tray is disposed directly on and in direct contact with (e.g., with only an adhesive therebetween or in direct physical contact with) the cooling plate;

the upper level battery cell array is disposed directly on and in direct contact with (e.g., with only an adhesive therebetween or in direct physical contact with) the upper level negative cell tray;

the upper level positive cell tray is disposed directly on and in direct contact with (e.g., with only an adhesive therebetween or in direct physical contact with) the upper level battery cell array; and the top current collector assembly is disposed directly on and in direct contact with (e.g., with only an adhesive therebetween or in direct physical contact with) the upper level positive cell tray.

Embodiment 40. The battery pack according to any of embodiments 29-39, wherein each battery module of the plurality of battery modules further comprises a single center fastener (e.g., center tube and/or center bolt assembly) that goes through respective holes of the top current collector assembly, the upper level positive cell tray, the upper level battery cell array, the upper level negative cell tray, the cooling plate, the lower level negative cell tray, the lower level battery cell array, the lower level positive cell tray, and the bottom current collector assembly to clamp the entire battery module together.

Embodiment 41. The battery pack according to any of embodiments 29-40, wherein, within each battery module of the plurality of battery modules, the cooling plate comprises a top plate.

Embodiment 42. The battery pack according to any of embodiments 29-41, wherein, within each battery module of the plurality of battery modules, the cooling plate comprises grooves, dimples, and/or other indentations or protrusions on an upper and/or lower surface thereof.

Embodiment 43. The battery pack according to any of embodiments 29-42, wherein, within each battery module of the plurality of battery modules, the cooling plate comprises at least one end protrusion protruding from an end thereof and having a post extending upwards therefrom.

Embodiment 44. The battery pack according to embodiment 43, wherein, within each battery module of the plurality of battery modules, the cooling plate comprises a connector disposed on the post.

Embodiment 45. The battery pack according to any of embodiments 29-42, wherein, within each battery module of the plurality of battery modules, the cooling plate comprises a first end protrusion protruding from a first end thereof and having a first post extending upwards therefrom, and a second end protrusion protruding from a second end thereof (opposite from the first end) and having a second post extending upwards therefrom.

Embodiment 46. The battery pack according to embodiment 45, wherein, within each battery module of the plurality of battery modules, the cooling plate comprises a first connector disposed on the first post and a second connector disposed on the second post.

Embodiment 47. The battery pack according to any of embodiments 1-46, wherein each battery module of the plurality of battery modules comprises at least one vertical interconnection (e.g., at an end thereof, in a width-wise direction in which the structural cross-members extend, and which can be used to connect to at least one conductive line of the battery pack that can electrically connect the battery modules or pairs of battery modules to each other).

Embodiment 48. A method of providing battery power to an electric passenger vehicle, the method comprising:

providing a battery pack according to any of embodiments 1-47 to the electric passenger vehicle; and connecting the battery pack to the electric passenger vehicle such that the battery pack provides battery power to the electric passenger vehicle.

Embodiment 49. A method of fabricating a battery pack for an electric passenger vehicle, the method comprises:

forming (e.g., extruding) a housing comprising a frame and a plurality of structural cross-members defining a plurality of module spaces within the housing; and

respectively disposing a plurality of battery modules in at least a portion of (or in all of) the module spaces of the plurality of module spaces.

Embodiment 50. The method according to embodiment 49, wherein the battery pack has any of the additional features recited in any of embodiments 2-47.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A battery pack for electric passenger vehicles, the battery pack comprising:
a housing comprising a frame and a plurality of structural cross-members defining a plurality of module space pairs within the housing; and
a plurality of battery modules respectively disposed in pairs in module space pairs of the plurality of module space pairs.

2. The battery pack according to claim 1, wherein within each module space pair, two battery modules are disposed and are electrically connected to each other via an interconnection.

3. The battery pack according to claim 1, wherein each battery module of the plurality of battery modules is electrically connected to a conductive line running through the housing, the conductive line being electrically connected to at least one external contact configured to connect to the electric passenger vehicle.

4. The battery pack according to claim 1, wherein the housing further comprises a buffer space between, in a length-wise direction of the battery pack, the plurality of module space pairs and an end portion of the housing.

5. The battery pack according to claim 1, wherein the frame of the housing comprises a plurality of housing fasteners.

6. The battery pack according to claim 1, wherein the frame of the housing is an extruded frame, and
wherein the housing is an extruded housing.

7. The battery pack according to claim 1, wherein the plurality of module space pairs comprises five module space pairs comprising ten module spaces.

8. The battery pack according to claim 1, wherein the plurality of battery modules comprises ten battery modules.

9. The battery pack according to claim 1, wherein the plurality of structural cross-members comprises at least five structural cross-members.

10. The battery pack according to claim 1, wherein the plurality of structural cross-members comprises at least five structural cross-members defining five module space pairs.

11. The battery pack according to claim 1, further comprising a lid cover disposed on the housing and covering an opening of the housing, such that the plurality of battery modules are enclosed within the housing and the lid cover.

12. The battery pack according to claim 11, wherein the lid cover is removably attached to the housing via at least one cover fastener that goes through the lid cover and fastens it to the housing.

13. The battery pack according to claim 11, wherein the lid cover comprises a plurality of embossed portions.

14. The battery pack according to claim 13, further comprising at least one center fastener that goes through respective holes of the top current collector assembly, the upper level positive cell tray, the upper level battery cell array, the upper level negative cell tray, the bottom current collector assembly, the lower level positive cell tray, the lower level battery cell array, and the lower level negative cell tray.

15. The battery pack according to claim 13, wherein the embossed portions of the plurality of embossed portions are respectively provided over battery modules of the plurality of battery modules.

16. The battery pack according to claim 13, wherein the embossed portions of the plurality of embossed portions are respectively provided over structural cross-members of the plurality of structural cross-members.

17. The battery pack according to claim 1, wherein a width of the battery pack, measured in a first direction in which the structural cross-members run, is in a range of from 4 feet to 6 feet,
wherein a length of the battery pack, measured in a second direction perpendicular to the first direction and parallel to a lower surface of the housing, is in a range of from 6 feet to 15 feet, and
wherein a thickness of the battery pack, measured in a third direction perpendicular to the first direction, the second direction, and the lower surface of the housing, is in a range of from 2 inches to 24 inches.

18. The battery pack according to claim 1, wherein a thickness of the housing, measured in a third direction perpendicular to a lower surface of the housing, is large enough for the plurality of battery modules to be disposed in the housing and be laterally completely contained within the housing.

19. A battery pack for electric passenger vehicles, the battery pack comprising:
a housing comprising a frame and a plurality of structural cross-members defining a plurality of module space pairs within the housing;
a plurality of battery modules respectively disposed in pairs in module space pairs of the plurality of module space pairs; and
a lid cover disposed on the housing and covering an opening of the housing, such that the plurality of battery modules are enclosed within the housing and the lid cover,
wherein within each module space pair, two battery modules are disposed and are electrically connected to each other via an interconnection.
wherein each battery module of the plurality of battery modules is electrically connected to a conductive line running through the housing, the conductive line being electrically connected to at least one external contact configured to connect to the electric passenger vehicle,
wherein the housing further comprises a buffer space between, in a length-wise direction of the battery pack, the plurality of module space pairs and an end portion of the housing,
wherein the frame of the housing comprises a plurality of housing fasteners,
wherein the frame of the housing is an extruded frame,
wherein the housing is an extruded housing,
wherein the plurality of module space pairs comprises five module space pairs comprising ten module spaces,
wherein the plurality of battery modules comprises ten battery modules,
wherein the plurality of structural cross-members comprises at least five structural cross-members defining the five module space pairs,
wherein the lid cover is removably attached to the housing via at least one cover fastener that goes through the lid cover and fastens it to the housing,
wherein the lid cover comprises a plurality of embossed portions,
wherein the embossed portions of the plurality of embossed portions are respectively provided over battery modules of the plurality of battery modules or over structural cross-members of the plurality of structural cross-members,
wherein a width of the battery pack, measured in a first direction in which the structural cross-members run, is in a range of from 4 feet to 6 feet,
wherein a length of the battery pack, measured in a second direction perpendicular to the first direction and parallel to a lower surface of the housing, is in a range of from 6 feet to 15 feet,
wherein a thickness of the battery pack, measured in a third direction perpendicular to the first direction, the second direction, and the lower surface of the housing, is in a range of from 2 inches to 24 inches, and
wherein the thickness of the housing, measured in the third direction, is large enough for the plurality of battery modules to be disposed in the housing and be laterally completely contained within the housing.

20. The battery pack according to claim 19, wherein each battery module of the plurality of battery modules comprises:
a bottom current collector assembly;
a lower level positive cell tray disposed directly on in direct contact with the bottom current collector assembly;
a lower level battery cell array disposed directly on in direct contact with the lower level positive cell tray;
a lower level negative cell tray disposed directly on in direct contact with the lower level battery cell array;
a cooling plate disposed directly on in direct contact with the lower level negative cell tray;
an upper level negative cell tray disposed directly on in direct contact with the cooling plate;
an upper level battery cell array disposed directly on in direct contact with the upper level negative cell tray;
an upper level positive cell tray disposed directly on in direct contact with the upper level battery cell array;
a top current collector assembly disposed directly on in direct contact with the upper level positive cell tray;
scalloped side caps covering respective lateral sides of the lower level positive cell tray, the lower level battery cell array, the lower level negative cell tray, the upper level negative cell tray, the upper level battery cell array, and the upper level positive cell tray;
main terminal holders on respective ends of the battery module;
an upper level center fastener that goes through respective holes of the top current collector assembly, the upper level positive cell tray, the upper level battery cell array, and the upper level negative cell tray; and
a lower level center fastener that goes through respective holes of the bottom current collector assembly, the lower level positive cell tray, the lower level battery cell array, and the lower level negative cell tray.
